(19) United States
(12) Patent Application Publication
(10) Pub. No.: US 2009/0307510 A1
(43) Pub. Date: Dec. 10, 2009

(54) PROCESSOR AND POWER CONTROLLING METHOD THEREOF

(75) Inventor: Hiroaki ATSUMI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/406,238

(22) Filed: Mar. 18, 2009

(30) Foreign Application Priority Data
Jun. 4, 2008 (JP) 2008-147331

(51) Int. Cl. G06F 1/32

(52) U.S. Cl. 713/322

(57) ABSTRACT

A processor including a plurality of computation circuit blocks each having a function to perform a computation for each of a plurality of pieces of divided data to be computed, and a function to power on/off each power supply includes a signal value fixing circuit, which is provided for each of the computation circuit blocks, for fixing one or both of signal values of an input and an output of each of the computation circuit blocks, and a power supply control sequencer circuit for instructing each signal value fixing circuit to fix the signal value or to release the signal value from being fixed, and for respectively instructing the computation circuit blocks to power on/off each power supply in a step-by-step manner on the basis of a power supply control signal provided from an instruction controlling circuit for controlling an input of a computation instruction to the processor.

### CROSS-REFERENCE TO RELATED APPLICATIONS

This application is based upon and claims the benefit of priority of the prior Japanese Patent Application No. 2008-147331, filed on Jun. 4, 2008, the entire contents of which are incorporated herein by reference.

### FIELD

The embodiments discussed herein are related to a semiconductor device power control technique.

### BACKGROUND

With the shrinkage of semiconductor devices, leak currents such as one that flows between the source terminal and the drain terminal of a transistor, or the like have been increasing relatively with the operating current of a circuit. A high-performance CPU (Central Processing Unit) consumes a lot of power, and dissipates a large amount of heat.

Conventionally, a method for halting the switching operations of gates and transistors is adopted to reduce power consumption. However, for a leak current that flows even when a transistor is in an OFF state, its influence has recently become too large to be ignored. As a result, only the method for controlling the switching of transistors has become insufficient. Accordingly, attention is focused, as a method for reducing power, on a method for temporarily powering off the power supply of a circuit that does not execute a valid process when an instruction is executed even during the operations of an LSI, and for again powering on the circuit on demand.

FIG. 18 depicts a configuration of a conventional typical power control technique.

Conventionally, for a target block 1801 of this size, its power supply is powered on/off at one time when the power supply is controlled.

An instruction to power off a power supply is made with a power supply control signal 1804 issued from an instruction controlling unit 1803. The target block 1801 is composed of, for example, blocks (BLOCKs) 1802 (#0 to #3). A feeding FET 1805 operates based on the power supply control signal 1804. A power supply VDD to the blocks (BLOCKs) 1802 (#0 to #3) is powered off at one time by the feeding FET 1805.

A signal (the same signal as the power supply control signal 1804 in FIG. 18) is transmitted also to a receiving side the same time the power supply VDD is powered off. An input fixing circuit 1806 on a receiving side, which operates based on the transmitted signal, gates an output signal. In the target block 1801 that is powered off, its output signal is not driven. Therefore, the value output from the target block 1801 becomes indefinite. Another arithmetic unit, register 1807, etc. is configured so that a problem is not caused in its operations by gating an input signal in the input fixing circuit 1806 on the receiving side to settle the value of the input signal even if an indefinite value comes from the target block 1801 that is powered off.

Japanese Laid-open Patent Publications Nos. H8-202468, H7-271477, 2006-244519 and 2006-303579 are disclosed as conventional technology.

With CMOS (Complementary Metal-Oxide Semiconductor) technology, a high current sometimes flows as one type of an inrush current at the time of power-on or power-off of a power supply. At this time, a power supply voltage momentarily makes a significant change. This voltage fluctuation causes a malfunction in some cases.

To cope with such a case, a time constant is increased by connecting a lot of capacitors of high response to the power supply. However, capacitors of larger capacity are required with an increase in the amount of fluctuations, and this is not very much practical.

### SUMMARY

In one aspect of the embodiments, a processor including a plurality of computation circuit blocks each having a function to perform a computation for each of a plurality of pieces of divided data to be computed, which are divided based on bit positions of data to be computed, and a function to power on/off each power supply includes a signal value fixing circuit, which is provided for each of the computation circuit blocks, for fixing one or both of signal values of an input and an output of each of the computation circuit blocks, and a power supply control sequencer circuit for instructing each signal value fixing circuit to fix a signal value and to release the signal value from being fixed, and for respectively instructing the computation circuit blocks to power on/off each power supply in a step-by-step manner on the basis of a power supply control signal provided from an instruction controlling circuit for controlling an input of a computation instruction to the processor.

In another aspect of the embodiments, a processor including a first computation circuit for performing a computation for first divided data to be computed, which is divided based on bit positions of data to be computed, a second computation circuit for performing a computation for second divided data to be computed that is divided on bit positions of the data to be computed and different from the first data, and a control circuit for controlling the first computation circuit and the second computation circuit, wherein the first computation circuit includes a first input value fixing circuit, to which the first divided data to be computed is input, for outputting one of the first divided data to be computed and a first fixed input value on the basis of a first fixed value control signal, and a first divided computation circuit for performing a first computation for the first divided data to be computed, and for outputting first divided computed output data, the second computation circuit includes a second input value fixing circuit, to which the second divided data to be computed is input, for outputting one of the second divided data to be computed and a second fixed input value on the basis of a second fixed value control signal, and a second divided computation circuit for performing a second computation for the second divided data to be computed, and for outputting second divided computed output data, and the control circuit outputs the first fixed value control signal to the first computation circuit, and outputs the second fixed value control signal to the second computation circuit on the basis of an external control signal input externally to the control circuit.

The object and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

FIG. 1 is a block diagram depicting a simplified configuration of a CPU targeted by an embodiment;

FIG. 2 is a flowchart depicting the operations of an entire control performed when a power supply is powered off in the embodiment;

FIG. 3 is a schematic diagram depicting implementation examples of a calculator 103-1 of FIG. 1, which has a power supply control function, and its peripheral circuits;

FIG. 4 is a circuit diagram depicting a configuration for settling an output signal 402 to a fixed value of 0 on the basis of a control signal 403 regardless of an input signal 401;

FIG. 5 is a schematic diagram depicting another implementation example of the calculator 103-1 of FIG. 1, which has the power supply control function, and its peripheral circuits;

FIG. 6 is a circuit diagram depicting a configuration example of a power supply control sequencer 302 depicted in FIG. 3 or 5;

FIG. 7 is an operational timing chart when the power supply control sequencer 302 (see FIG. 3, etc.) having the configuration depicted in FIG. 6 powers on a power supply;

FIG. 8 is an operational timing chart when the power supply control sequencer 302 powers off the power supply;

FIG. 9 is an operational timing chart when the power supply control sequencer 302 switches to a power-on sequence during a power-off sequence;

FIG. 10 is a flowchart depicting operations performed when the function of the power supply control sequencer 302 of FIG. 3 (or FIG. 5) having the configuration depicted in FIG. 6 is represented as software operations;

FIG. 11 is a circuit diagram depicting an embodiment of a circuit configuration for holding the value of an output signal to be definite;

FIG. 12 is a circuit diagram depicting another embodiment of a circuit configuration for holding the value of an output signal to be definite;

FIG. 13 is a schematic diagram depicting a configuration example of queue groups 102-2 within an instruction controlling unit 102 of FIG. 1;

FIG. 14 is a schematic diagram depicting an example of an entry format of an IQ 1301 (FIG. 13) required for a power supply control;

FIG. 15 is a schematic diagram depicting an example of a circuit for detecting an active instruction within the IQ 1301 (FIG. 13) to a calculator 103-1 (FIG. 1);

FIG. 16 is a schematic diagram depicting an example of a circuit for detecting an active instruction within the EQ 1303 or an RS 1302 (FIG. 13) to the arithmetic unit 103-1 (FIG. 1);

FIG. 17 is a circuit diagram depicting a configuration for generating a power supply control signal “power control sig” from valid instruction detection signals, which respectively correspond to the IQ 1301, the RS 1302 and an EQ 1303, a configuration for counting the duration of power-off, and a configuration for generating a control signal for causing a data move from the RS 1302 to the EQ 1303 (FIG. 13) to wait; and

FIG. 18 is a block diagram depicting a configuration of a conventional typical power supply control technique.

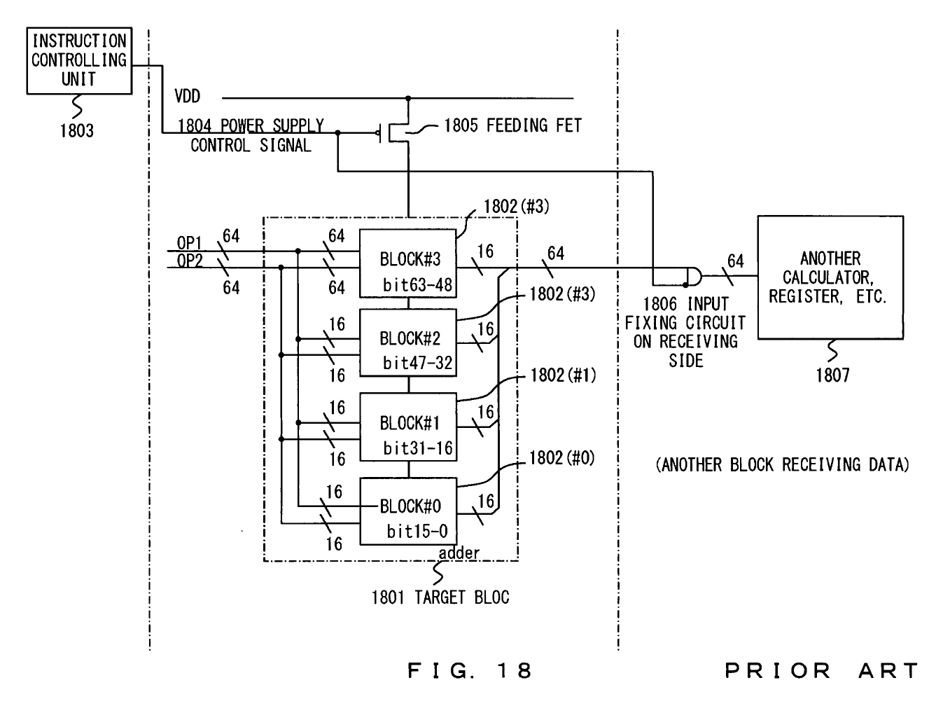

### DESCRIPTION OF EMBODIMENTS

The embodiments refer to the suppression of voltage fluctuations by decreasing the amount of voltage fluctuations occurring at one time with a control enabled for a power supply of each of circuit blocks into which a computation circuit that is a component of a CPU, etc. is divided.

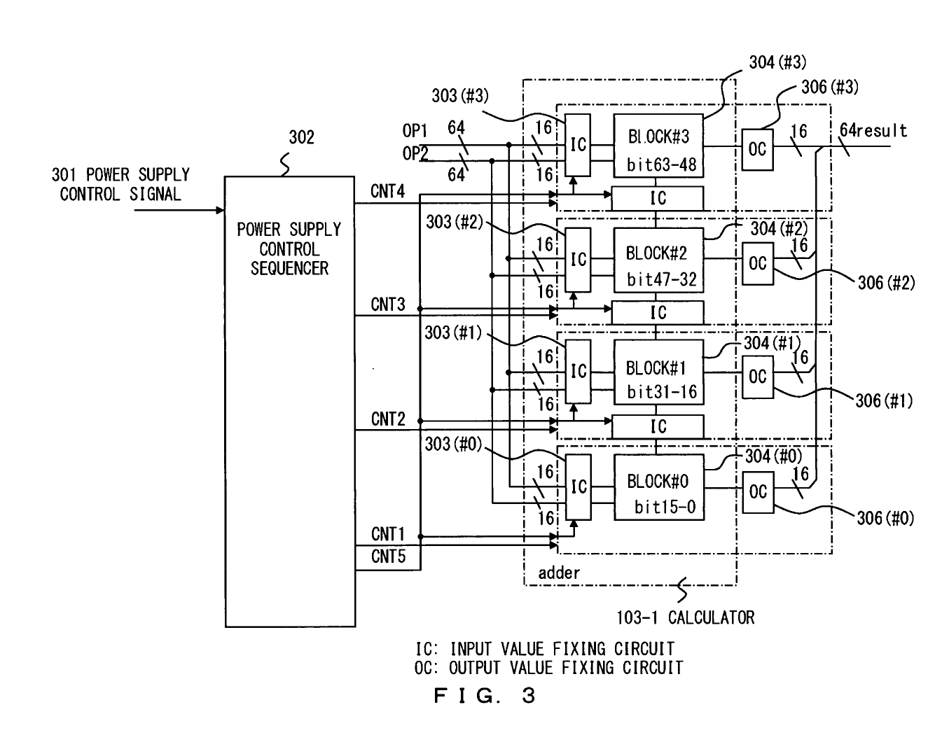

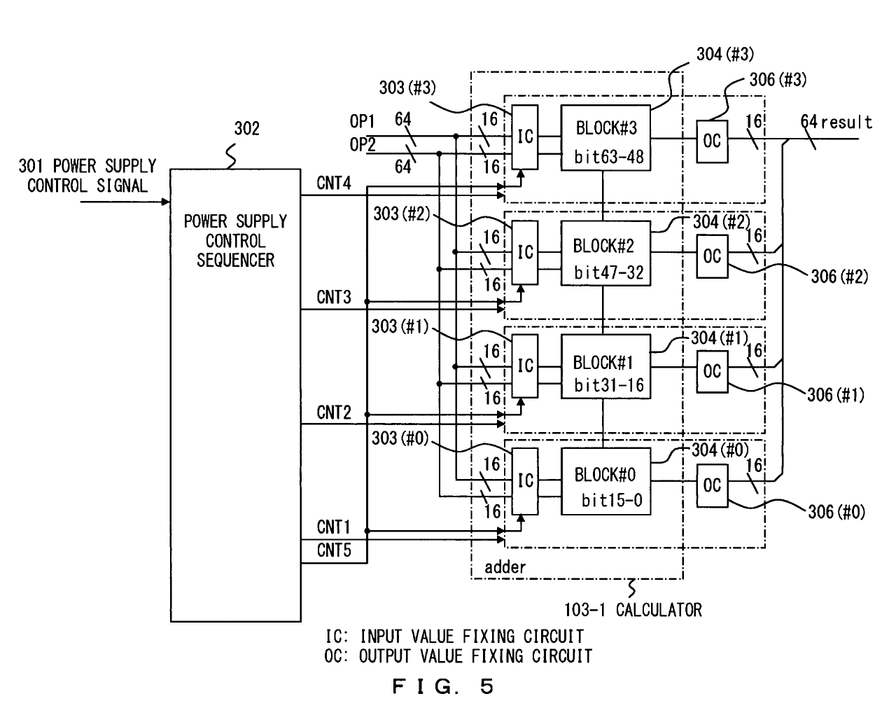

A first embodiment assumes a processor including a plurality of computation circuit blocks (304 of FIGS. 3 and 5), each of which has a function to perform a computation for each of a plurality of pieces of divided data to be computed obtained by dividing data to be computed on the basis of bit positions, and to power on/off each power supply, or a power supply controlling method of the processor.

Signal value fixing circuits (303 and 306 of FIGS. 3 and 5) are respectively provided for the computation circuit blocks. Either or both of signal values of an input and an output of each of the computation circuit blocks are fixed.

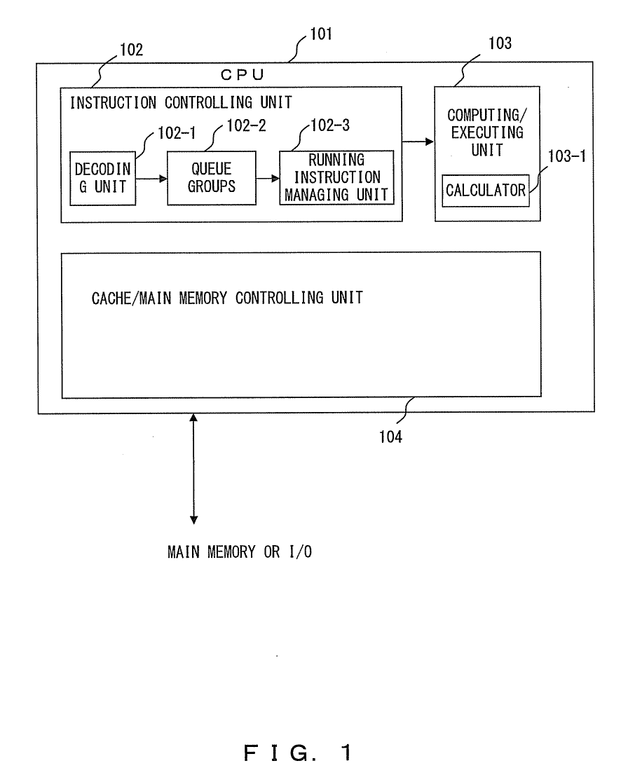

A power supply control signal (301 of FIGS. 3 and 5) is provided from an instruction controlling circuit (102 of FIG. 1) for controlling the input of a computation instruction to the processor. A power supply control sequencer circuit (302 of FIGS. 3 and 5) instructs each signal value fixing circuit to fix a signal value and to release the signal value from being fixed, and respectively instructs the computation circuit blocks to power on/off each power supply in a step-by-step manner on the basis of the power supply control signal (301 of FIGS. 3 and 5).

If the power supply control signal instructs the power-off of a power supply, the power supply control sequencer circuit instructs each signal value fixing circuit to fix, for example, a signal value on the input side. Thereafter, the power supply control sequencer circuit respectively instructs the computation circuit blocks to power off each power supply in a step-by-step manner from the computation circuit block on the most significant bit side of data to be computed. Or, if the power supply control signal is a signal that instructs the power-on of a power supply, the power supply control sequencer circuit respectively instructs the computation circuit blocks to power on each power supply in a step-by-step manner, for example, from the computation circuit block on the least significant bit side of the data to be computed. Thereafter, the power supply control sequencer circuit instructs each signal value fixing circuit to release the signal value on the input side from being fixed.

Alternatively, if the power supply control signal instructs the power-off of a power supply, the power supply control sequencer circuit instructs each signal value fixing circuit to fix, for example, the signal value on the input side. Thereafter, the power supply control sequencer circuit respectively instructs the computation circuit blocks to power off each power supply in a step-by-step manner from the computation circuit block on the most significant bit side of the data to be computed. Simultaneously with this instruction, the power supply control sequencer circuit also instructs the signal value fixing circuit, which corresponds to the computation circuit block instructed to power off its power supply, to fix the signal value on the output side. Or, if the power supply control signal is a signal that instructs the power-on of a power supply, the power supply control sequencer circuit respectively instructs the computation circuit blocks to power on each power supply in a step-by-step manner, for example, from the computation circuit block on the least significant bit side of the data to be computed. Simultaneously with this instruction, the power supply control sequencer circuit instructs the signal value fixing circuit, which corresponds to the computation circuit block instructed to power on its power supply, to release the signal value on the output side from being fixed. Thereafter, the power supply control sequencer circuit instructs each signal value fixing circuit to release the signal value on the input side from being fixed.

A second embodiment assumes a processor including a first computation circuit, a second computation circuit and a control circuit. The first computation circuit performs a computation for first divided data to be computed, which is divided on the basis of bit positions in data to be computed. The second computation circuit performs a computation for second divided data to be computed that is divided on the basis of bit positions in the data to be computed and different from the first data to be computed. The control circuit controls the first and the second computation circuits.

The first computation circuit includes a first input value fixing circuit and a first divided computation circuit. The first input value fixing circuit, to which the first divided data to be computed is input, outputs either of the first divided data to be computed and a first fixed input value on the basis of a first fixed value control signal. The first divided computation circuit performs a first computation for the first divided data to be computed, and outputs the first divided computed output data.

The second computation circuit includes a second input value fixing circuit and a second divided computation circuit. The second input value fixing circuit, to which the second divided data to be computed is input, outputs either of the second divided data to be computed and a second fixed input value on the basis of a second fixed value control signal. The second divided computation circuit performs a second computation for the second divided data to be computed, and outputs second divided computed output data.

The control circuit outputs the first fixed value control signal to the first computation circuit, and outputs the second fixed value control signal to the second computation circuit on the basis of an external control signal input externally to the control circuit.

The above described configuration of the second embodiment may be implemented so that the first computation circuit is further connected to the second computation circuit via a carry signal fixing circuit, and outputs a carry signal to the second computation circuit. At this time, the carry signal fixing circuit may be configured to suppress the carry signal output from the first computation circuit to the second computation circuit, and to output a third fixed value on the basis of the second fixed value control signal.

Additionally, the configuration of the second embodiment described up to this point may be implemented so that the first computation circuit further includes a first output value fixing circuit and a second output value fixing circuit. In this case, the first output value fixing circuit, to which the first divided computed output data is input, outputs either of the first divided computed output data and the second fixed output value on the basis of the first fixed value control signal. The second output value fixing circuit, to which the second divided computed output data is input, outputs either of the second divided computed output data and the second fixed output value on the basis of the second fixed value control signal.

Additionally, the configuration of the second embodiment described up to this point may be implemented so that the control circuit further outputs the first power supply control signal for controlling the power supply of the first computation circuit to the first computation circuit on the basis of the external control signal input externally to the control circuit. In this case, the control circuit may be configured to output the second power supply control signal for controlling the power supply of the second computation circuit to the second computation circuit.

With the above described configurations of the processor and the power supply control method thereof according to the embodiment, each power supply can be controlled for each of divided computation circuit blocks configuring a processor. As a result, the amount of voltage fluctuations occurring (ripple of voltage) at one time can be reduced.

Embodiments of the processor and the power supply controlling method thereof are described in detail below with reference to the drawings.

FIG. 1 is a block diagram depicting a simplified configuration of a CPU targeted by this embodiment.

The CPU 101 includes an instruction controlling unit 102, a computing/executing unit 103, a cache/main memory controlling unit 104, and the like. In this embodiment, the processor and the power supply controlling method thereof are implemented by performing a power supply control for a calculator 103-1 included in the computing/executing unit 103. The calculator is used as one component configuring a CPU in many cases, and is a functional block for making a calculation and processing data. The calculator is not limited to the configuration depicted in the computing/executing unit 103 of FIG. 1, and an equivalent calculator is applicable to this embodiment.

The instruction controlling unit 102 within the CPU 101 includes an instruction decoding unit 102-1, various types of queue groups 102-2 related to the execution of instructions, and a running instruction managing unit 102-3 for managing a running instruction or its similar state management mechanism. In this embodiment, the instruction controlling unit 102 grasps the state of the computing/executing unit 103, and decides the power-off and re-power-on of a power supply.

Additionally, the instruction controlling unit 102 has a characteristic of holding almost no values if there are no valid processing instructions. Accordingly, the instruction controlling unit 102 does not require the storage of its state when the power supply is powered off. Accordingly, the instruction controlling unit 102 is a functional block that can implement a power supply control with relative ease when the power supply control is performed.

The calculator 103-1 within the computing/executing unit 103 executes a process in accordance with an instruction issued from the instruction controlling unit 102. The instruction controlling unit 102 manages the state of the calculator 103-1. Therefore, it is convenient that the instruction controlling unit 102 generates a power supply control signal to the calculator 103-1.

This embodiment suppresses voltage fluctuations by decreasing the amount of voltage fluctuations occurring at one time with a power supply control enabled for each of divided circuit blocks of the calculator 103-1.

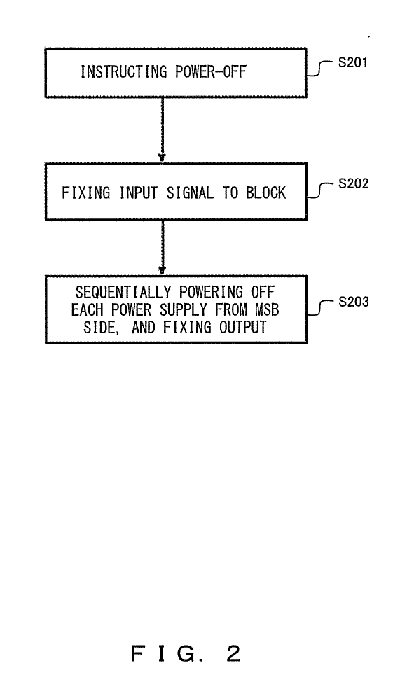

FIG. 2 is a flowchart depicting the operations of an entire control when a power supply is powered off in this embodiment.

Firstly, an instruction to power off each power supply is issued by the instruction controlling unit 102 of FIG. 1 (S201 of FIG. 2).

Next, an input signal to each computation block (hereinafter referred to simply as a block) within the calculator 103-1 of FIG. 1 is fixed (S202 of FIG. 2). In this embodiment, a logic circuit, which will be described later, for fixing an input signal to each block of the calculator 103-1 is provided. With this logic circuit, an unexpected current is prevented from flowing due to a change in an input signal at the time of execution of a power supply sequence.

Then, each power supply is powered off from the MSB (Most Significant Bit) side (step S203 of FIG. 2). This control eliminates the need for adding a circuit that suppresses a signal, leading to reductions in power applied to a protection mechanism. Furthermore, a circuit for holding the value of a signal output from each powered-off block to be definite is added, and another block in a succeeding stage can learn the state of power-off. This can eliminate the need for a circuit for notifying a conducted block of a special state. Moreover, this embodiment is configured so that the power supply of an output unit of a block can be controlled by disconnecting the power supply from the block. With this configuration, the power-off of the output driver of a block and the fixing of the value of an output can be simultaneously controlled with the power supply control signal. In this way, data on a communications bus does not become indefinite on a receiving side, thereby eliminating the need for providing a special circuit on the receiving side.

As described above, a load of current fluctuations on a power supply when the power supply of a particular calculator block is powered off is minimized during the operations of an LSI.

FIG. 3 is a block diagram depicting configurations of implementation examples of the calculator 103-1 of FIG. 1, which has the power supply control function, and its peripheral circuits. The example of this calculator 103-1 is an adder. However, a calculator that performs another computation can be configured in a similar manner.

OP1 and OP2 respectively represent input operand data buses to the calculator 103-1 that is the adder. Moreover, “result” represents the output data of an addition result of the calculator 103-1.

The power supply control sequencer 302 receives an external instruction to power-on/off a power supply with the power supply control signal 301. The power supply control sequencer 302 controls power supply control signals CNT1, CNT2, CNT3, CNT4 and an input signal control signal CNT5 with the received power supply control signal 301.

BLOCKs 304 (#0 to #3) represent four portions into which the adder is divided. For example, a 64-bit adder is divided into portions of 16 bits. In this case, BLOCK 304 (#0) is defined as a block responsible for bits 15 to 0, BLOCK 304 (#1) is defined as a block responsible for bits 31 to 16, BLOCK 304 (#2) is defined as a block responsible for bits 47 to 32, and BLOCK 304 (#3) is defined as a block responsible for bits 63 to 48.

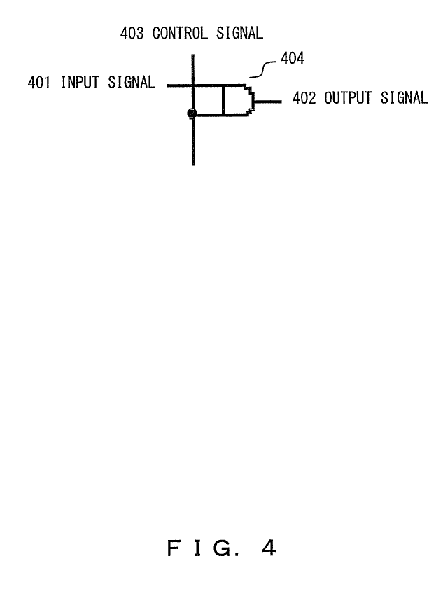

ICs 303 (#0 to #3) and ICs 305 (#1 to #3) are circuit blocks for settling an input signal to a fixed value. FIG. 4 is a circuit diagram depicting a circuit for settling an output signal 402 to a fixed value of 0 on the basis of a control signal 403 regardless of an input signal 401. The circuit depicted in FIG. 4 is configured with an AND circuit 404, and prepared by the number of bits of the input signal. If the control signal 403 is high-level, the value of the output signal 402 is equal to that of the input signal 401. If the control signal 403 is low-level, the output signal 402 is settled to the fixed value of 0. The control signal 403 corresponds to the CNT5 signal of FIG. 3.

The IC 305 (#1) between the BLOCK 304 (#0) and the BLOCK (#1), the IC 305 (#2) between the BLOCK 304 (#1) and the BLOCK (#2), and the IC 305 (#3) between the BLOCK 304 (#2) and the BLOCK (#3) are respectively fixing circuits for a carry signal between BLOCKs.

Power-off operations performed in this embodiment having the configurations depicted in FIGS. 3 and 4 are described.

Initially, power-off is notified with the power supply control signal 301 transmitted from the instruction controlling unit 102 (FIG. 1).

Next, the CNT5 signal is driven to a low level. Then all of the input signals and the carry signals are fixed in the ICs 303 (#0 to #3) and the ICs 305 (#1 to #3).

Then, the CNT4 signal is driven to a high level, and the BLOCK 304 (#3) is powered off.

Next, the CNT3 signal is driven to a high level, and the BLOCK 304 (#2) is powered off.

Then, the CNT2 signal is driven to a high level, and the BLOCK 304 (#1) is powered off.

Lastly, the CNT1 signal is driven to a high level, and the BLOCK 304 (#0) is powered off.

Re-power-on operations performed in this embodiment having the configurations depicted in FIGS. 3 and 4 are described.

Initially, power-on is notified with the power supply control signal 301 transmitted from the instruction controlling unit 102 (FIG. 1).

Next, the CNT1 signal is driven to a low level, and the BLOCK 304 (#0) is powered on.

Then, the CNT2 signal is driven to a low level, and the BLOCK 304 (#1) is powered on.

Next, the CNT3 signal is driven to a low level, and the BLOCK 304 (#2) is powered on.

Then, the CNT4 signal is driven to a low level, and the BLOCK 304 (#3) is powered on.

Lastly, the CNT5 signal is driven to a high level. Then, all of the input and the carry signals are released from being fixed by the ICs 303 (#0 to #3) and the ICs 305 (#1 to #3).

FIG. 5 is a circuit diagram depicting another implementation examples of the calculator 103-1 of FIG. 1, which has the power supply control function, and its peripheral circuits.

The configuration depicted in FIG. 5 is implemented by omitting the fixing circuit ICs 305 for a carry signal between BLOCKs 304 from the configuration depicted in FIG. 3.

As described with reference to FIG. 3, at the time of power-off, the BLOCKs 304 are powered off after all of the input signals OP1 and OP2 are initially settled to fixed values by the ICs 303. Then, at the time of power-on, the input signals OP1 and OP2 are released from being fixed after the BLOCKs 304 are powered on. As a result, the carry signals between the BLOCKs 304 remain unchanged and have a fixed value. At the time of power-off, a sequence for powering off the BLOCKs 304 sequentially from the BLOCK 304 on the MSB side is adopted. At the time of power-on, a sequence for powering on the BLOCKs 304 sequentially from the BLOCK 304 on the LSB side is adopted. As a result, the carry signal (the value of which can become an intermediate level) from a BLOCK 304 that is powered off is prevented from directly flowing into a BLOCK 304 that is powered on. Accordingly, the ICs 305 on the carry propagation path can be omitted.

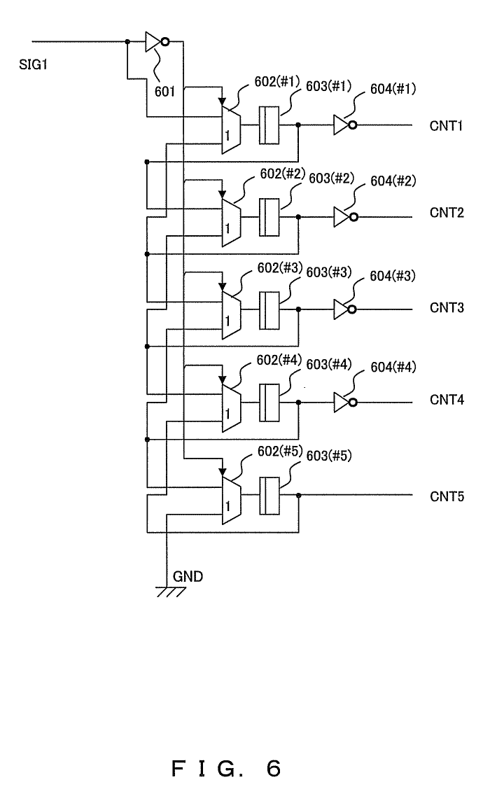

FIG. 6 is a circuit diagram depicting a configuration example of the power supply control sequencer 302 depicted in FIG. 3 or 5. This configuration is a shift-register configuration.

In FIG. 6, SIG1 is the power supply control signal 301 (see FIG. 3, etc.). SIG1 becomes 1 at power-off, and becomes 0 at power-on.

The power supply control signal SIG1 is generated by the running instruction managing unit 102-3 within the instruction controlling unit 102 depicted in FIG. 3. This is a signal for instructing the calculator 103-1 within the computing/executing unit 103 of FIG. 1 to power off its power supply if there is no execution instruction.

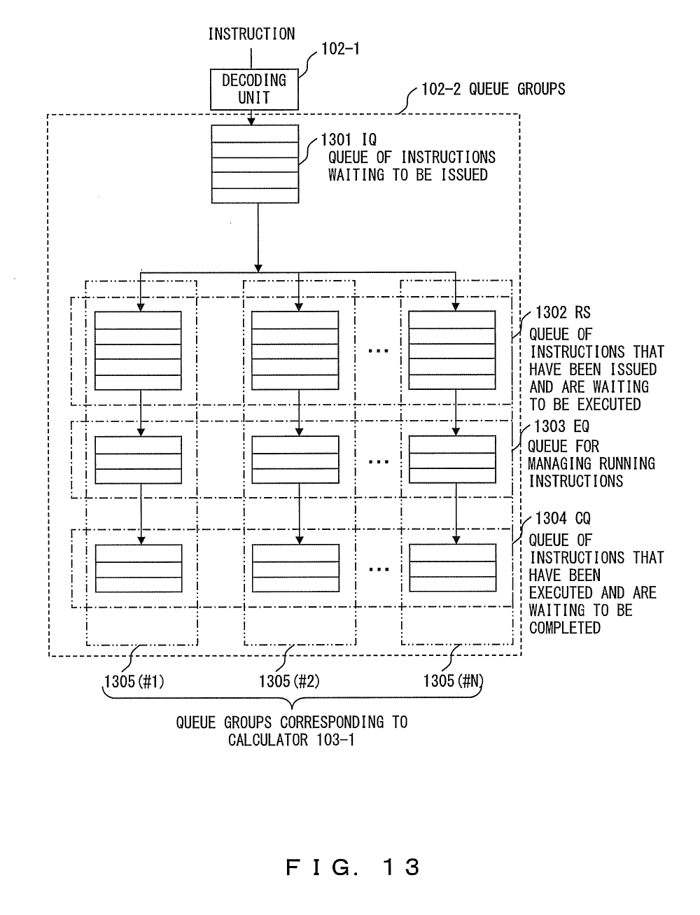

The instruction controlling unit 102 has an execution management queue for managing an instruction currently executed by the executing unit and the input timing of the next instruction, an instruction queue for preparing an instruction to be executed next, or similar information. With these queues, the state of the computing/executing unit 103 is managed. Accordingly, the running instruction managing unit 102-3 can learn that there is no running instruction in the computing/executing unit 103, and there is no instruction that will use the computing/executing unit 103. Details of the operations of the running instruction managing unit 102-3 will be described later with reference to FIGS. 13 to 17.

In FIG. 6, CNT1, CNT2, CNT3 and CNT4 are signals for a power supply control. CNT5 is a signal for cutting off an input signal. CNT1 to CNT4 are signals for powering on their corresponding BLOCKs 304 (see FIG. 3, etc.) when their values become 0. CNT5 is a signal for cutting off input signals to all of the BLOCKs 304 and setting each input to a fixed value when its value becomes 0.

In FIG. 6, a signal obtained by inverting the power supply control signal SIG1 with an inverter 601 controls select circuits 602 (#1 to #5). Each of the select circuits 602 selects the input on the upper side (the side not denoted with “1”) if the output signal of the inverter 601 is low-level, or selects the input on the lower side (the side denoted with “1”) if the output signal of the inverter 601 is high-level.

The outputs of the select circuits 602 (#1 to #5) are respectively latched by latch circuits 603 (#1 to #5). The outputs of the latch circuits 603 (#1 to #4) are respectively input to inverters 604 (#1 to #4). The outputs of the inverters 604 (#1 to #4) are output as the signals CNT1, CNT2, CNT3 and CNT4 (see FIG. 3). The output of the latch circuit 603 (#5) is output as the signal CNT5 (see FIG. 3).

To the input on the upper side of the select circuit 602 (#1), the power supply control signal SIG1 is input. To the input on the upper side of the select circuit 602 (#2), the output signal of the latch circuit 603 (#1) is input. To the input on the upper side of the select circuit 602 (#3), the output signal of the latch circuit 603 (#2) is input. To the input on the upper side of the select circuit 602 (#4), the output signal of the latch circuit 603 (#3) is input. To the input on the upper side of the select circuit 602 (#5), the output signal of the latch circuit 603 (#4) is input.

To the input on the lower side of the select circuit 602 (#5), a ground level (GND) equivalent to the low level is input. To the input on the lower side of the select circuit 602 (#4), the output signal of the latch circuit 603 (#5) is input. To the input on the lower side of the select circuit 602 (#3), the output signal of the latch circuit 603 (#4) is input. To the input on the lower side of the select circuit 602 (#2), the output signal of the latch circuit 603 (#3) is input. To the input on the lower side of the select circuit 602 (#1), the output signal of the latch circuit 603 (#2) is input.

As depicted in FIG. 3 or 5, the CNT1 signal is provided to the BLOCK 304 (#0) that is initially powered on, the CNT2 signal is provided to the BLOCK 304 (#1) that is powered on next, the CNT3 signal is provided to the BLOCK 304 (#2) that is powered on third, the CNT4 signal is provided to the BLOCK 304 (#3) that is powered on fourth, and the CNT5 signal is provided to the ICs 303 (#0 to #3) and the ICs 305 (#1 to #3) for fixing the input signals and the carry signals of the BLOCKs 304.

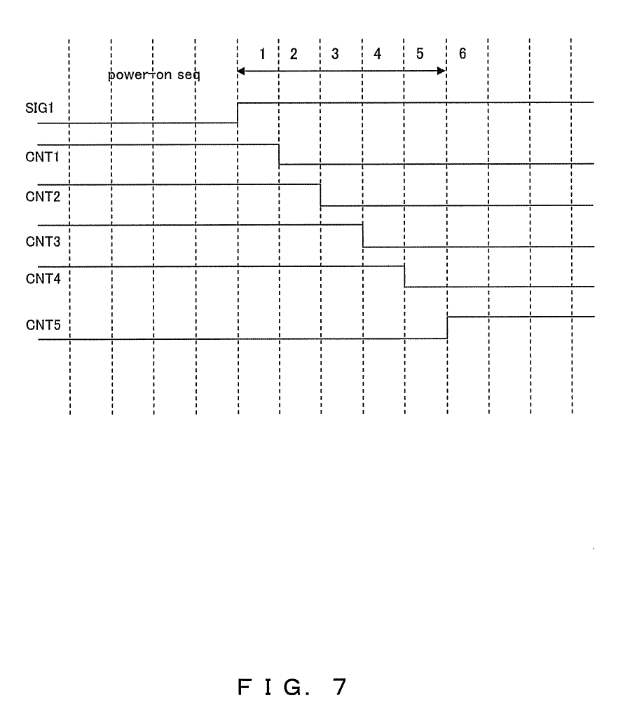

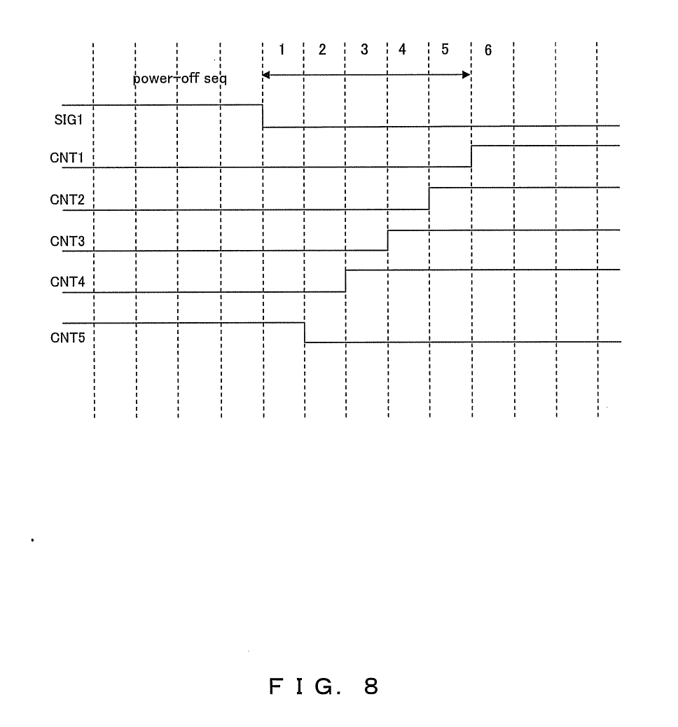

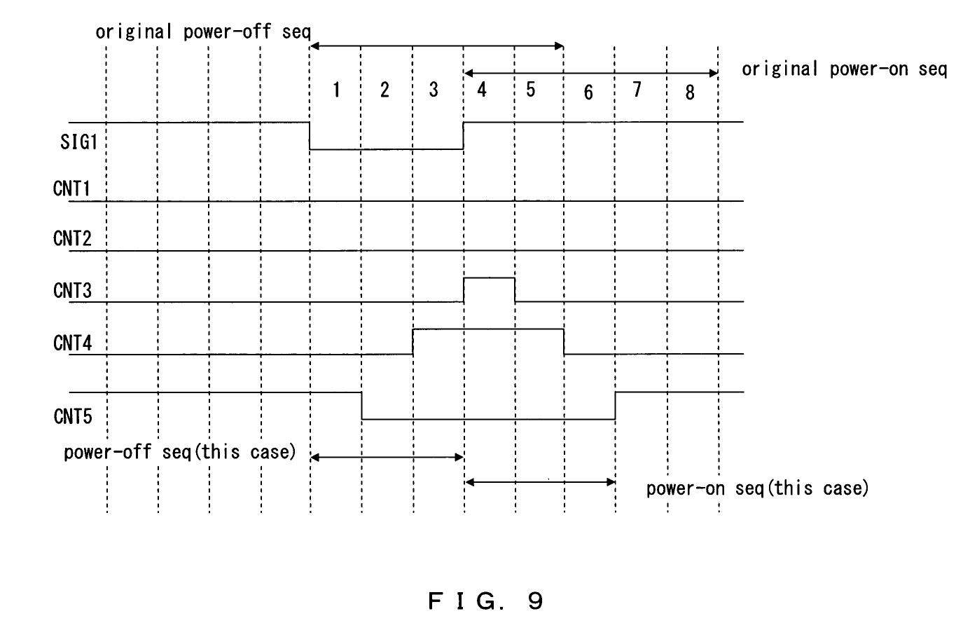

FIG. 7 is an operational timing chart when the power supply control sequencer 302 (see FIG. 3, etc.) having the configuration depicted in FIG. 6 powers on a power supply. FIG. 8 is an operational timing chart when the power supply control sequencer 302 powers off the power supply. FIG. 9 is an operational timing chart when the power supply control sequencer 302 switches to a power-on sequence during a power-off sequence.

Specific operations of the power supply control sequencer 302 having the configuration depicted in FIG. 6 are described with reference to the operational timing charts of FIGS. 7 to 9.

(1) To make a transition from the power-off state to the power-on state, the value of the power supply control signal SIG1 is driven to 1. As a result, a transition is made to the state of timing 1 depicted in FIG. 7. Consequently, a propagation from SIG1 to the select circuit 602 (#1) to the latch circuit 603 (#1) after one clock, from the latch circuit 603 (#1) to the select circuit 602 (#2) to the latch circuit 603 (#2) after two clocks, from the latch circuit 603 (#2) to the select circuit 602 (#3) to the latch circuit 603 (#3) after three clocks, from the latch circuit 603 (#3) to the select circuit 602 (#4) to the latch circuit 603 (#4) after four clocks, and from the latch circuit 603 (#4) to the select circuit 602 (#5) to the latch circuit 603 (#5) after five clocks occurs in FIG. 6. Then, the values of the CNT1 signal, the CNT2 signal, the CNT3 signal and the CNT4 signal sequentially become 0 in this order via the inverters 604 (#1 to #4). Lastly, the value of the CNT5 signal becomes 1.

(2) To make a transition from the power-on state to the power-off state, the value of the signal SIG1 is driven to 0. As a result, a transition is made to the state of timing 1 depicted in FIG. 8. In consequence, the selected state of each of the select circuits 602 (#1 to #5) is switched to the selection of the input on the lower side, and a propagation from the GND level to the select circuit 602 (#5) to the latch circuit 603 (#5) after one clock, from the latch circuit 603 (#5) to the select circuit 602 (#4) to the latch circuit 603 (#4) after two clocks, from the latch circuit 603 (#4) to the select circuit 602 (#3) to the latch circuit 603 (#3) after three clocks, from the latch circuit 603 (#3) to the select circuit 602 (#2) to the latch circuit 603 (#2) after four clocks, and from the latch circuit 603 (#2) to the select circuit 602 (#1) to the latch circuit 603 (#1) after five clocks occurs in FIG. 6. Then, the value of the CNT5 signal becomes 0. Thereafter, the values of the CNT4 signal, the CNT3 signal, the CNT2 signal and the CNT1 signal sequentially become 1 in this order via the inverters 604 (#4 to #1).

If the need for again making a transition to the power-on state during the power-off sequence of (2) arises, the power supply control signal is immediately switched to the power-on sequence by driving the value of the power supply control signal SIG1 to 1. Then, the power-on sequence starts at a BLOCK 304 that is not powered on yet, whereby a transition can be made to the power-on sequence without loss. An example of this operation is depicted in FIG. 9.

The original power-off sequence of this sequencer requires the timing 1 to the timing 5. Therefore, a transition is made to the power-on sequence by driving the value of the power supply control signal SIG1 to 1 at the timing 4 as depicted in FIG. 9. In the original power-off sequence, the value of the CNT2 signal becomes 1 at the timing 5 as depicted in FIG. 8. In the meantime, the value of the power supply control signal SIG1 changes to 1 at the timing 4 in the example of FIG. 9. Therefore, the operation is performed so that the value of the CNT3 signal is driven to 0 at the timing 5. In the case of FIG. 9, 3 [τ] (τ is a clock unit) is taken for the power-on sequence, and a transition to the power-on sequence is reduced from the original 5 [τ] to 3[τ], which proves no loss.

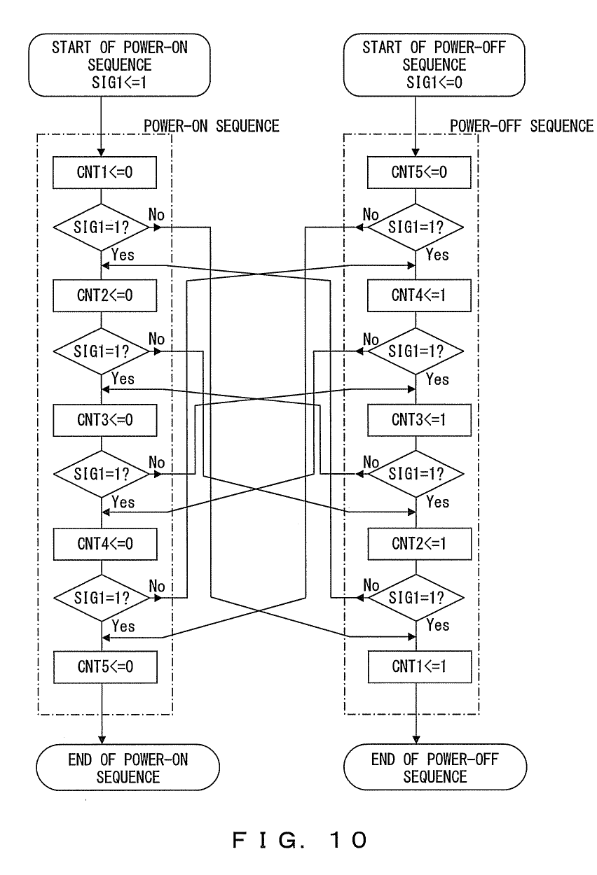

FIG. 10 is an operational flowchart in the case where the function of the power supply control sequencer 302 of FIG. 3 (or FIG. 5) having the configuration depicted in FIG. 6 is implemented as software operations.

In FIG. 10, the operational flow of the power-on sequence is depicted on the left side, whereas the operational flow of the power-off sequence is depicted on the right side. If a change is made to the instruction to shift to one sequence during the other sequence, an operation for referencing the signal SIG1 after every step and for making a branch is performed.

The case where the instruction to shift to one sequence during the other sequence is described below. Initially, the running instruction managing unit 102-3 depicted in FIG. 1 issues a power-off instruction after determining that there is no instruction to be input to the computing/executing unit 103 and may suspend the sequence. Thereafter, an instruction to be input to the computing/executing unit 103 newly appears. Namely, this instruction is newly added to the queue groups 102-2. In this case, the instruction to shift to one sequence is issued during the other sequence. The power-on sequence may be started upon completion of the power-off sequence in this case. However, it is preferable to immediately suspend the power-off sequence and to shift to the power-on sequence as described above, because the amount of time required to wait for the instruction input is reduced.

When a signal is externally output from a functional block that powers on/off a power supply, the output signal of that block is not driven at the time of power-off. Accordingly, a block that receives the signal from the block can possibly malfunction if it does not learn whether or not the transmitting block is operating. To avoid this, the signal is conventionally ignored by notifying the receiving block that the transmitting block is in the power-off state. Here, a method for eliminating the need for transmitting a special signal to a receiving side by holding the value of the output signal at the time of power-off or at the time of execution of the power-on sequence to be definite is described.

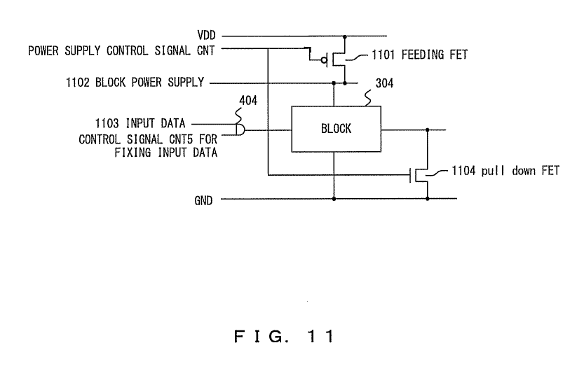

One method is to forcibly fix the value of the output signal of BLOCK 304 to the ground (GND) level at the time of power-off by providing a pull down FET 1104 on the output side of the BLOCK 304 (See FIG. 3, etc.) as depicted in FIG. 11.

The pull down FET 1104 is controlled by the power supply control signal CNT (corresponding to the CNT1 to the CNT4 of FIG. 3, etc.). With the pull down FET 1104, the value of the power supply control signal CNT makes a transition to the high level (see FIG. 8, etc.) with the power-off, and at the same time, the output signal line of the BLOCK 304 is short-circuited to the GND. Accordingly, the output of the BLOCK 304 is fixed to the GND level at the time of power-off.

The power supply of the BLOCK 304 itself is controlled by a feeding FET 1101. The feeding FET 1101 is controlled by the inverted input of the power supply control signal CNT. When the value of the power supply control signal CNT is low-level (see FIG. 7, etc.) with the power-on, the feeding FET 1101 is conducted. As a result, a BLOCK power supply 1102 is connected to the power supply VDD. When the value of the power supply control signal CNT makes a transition to the high level with the power-off, the feeding FET 1101 disconnects the BLOCK power supply 1102 from the power supply VDD.

Note that the AND gate 404 (provided for each input bit line) for fixing input data is similar to that described with reference to FIG. 4, and controlled by the CNT5 signal.

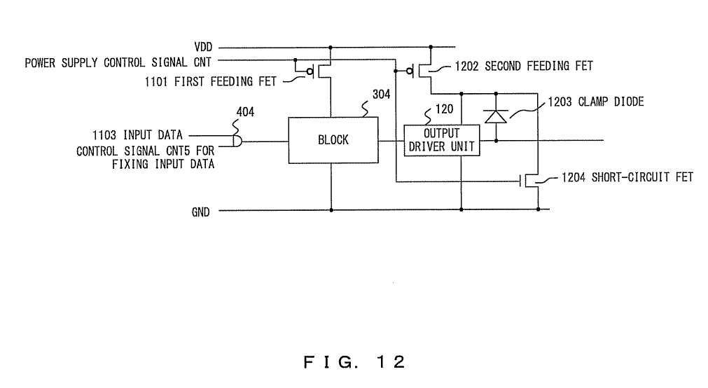

Another method for holding the value of the output signal to be definite is depicted in FIG. 12.

In the configuration depicted in FIG. 12, a feeding line to the BLOCK 304 (see FIG. 3, etc.) and an output driver unit 1201 of the BLOCK 304 is divided by the first feeding FET 1101 (the same as 1101 depicted in FIG. 11) and a second feeding FET 1202. A clamp diode 1203 is provided between the power supply VDD and the output signal line of the output driver unit 1202. Moreover, a short-circuit FET 1204 to the ground (GND) is provided for the power supply VDD of the output driver unit 1201.

When the value of the power supply control signal CNT is low-level (see FIG. 7, etc.) with the power-on, the first feeding FET 1101 and the second feeding FET 1202 are respectively conducted by the inverted input of the value of CNT. As a result, the BLOCK 304 and the output driver unit 1201 are connected to the power supply VDD respectively. Additionally, since the short-circuit FET 1204 is not conducted in this case, the output signal line of the output driver unit 1201 outputs a valid value from the BLOCK 304.

When the value of the power supply control signal CNT is driven to a high level with power-off, the first feeding FET 1101 and the second feeding FET 1202 operate on the basis of the inverted input of the value of CNT. As a result of the operations of the first feeding FET 1101 and the second feeding FET 1202, the BLOCK 304 and the output driver unit 1201 are respectively disconnected from the power supply VDD. Moreover, the short-circuit FET 1204 is conducted by the power supply control signal CNT in this case. As a result, the output signal line of the output driver unit 1201 is short-circuited to the GND through the clamp diode 1203. In consequence, the output of the BLOCK 304 is fixed to the GND level at power-off.

By enabling the power supply of the output unit of the BLOCK 304 to be controlled by disconnecting the power supply from the BLOCK 304, the power-off of the output driver unit 1201 and the circuit for settling the value of the output can be simultaneously controlled based on the power supply control signal CNT. In this way, data on a communications bus can be prevented from becoming indefinite on a receiving side, and the need for providing a special control circuit on the receiving side can be eliminated.

FIG. 13 is a schematic diagram depicting a configuration example of the queue groups 102-2 within the instruction controlling unit 102 of FIG. 1.

The queue groups 102-2 include one IQ (Issue Queue) 1301, and one RS (Reservation Station) 1302, one EQ (Execution Queue) 1303 and one CQ (Commit Queue) 1304, which are represented as 1305 (#1 to #N), for each calculator 103-1 (see FIG. 1).

The IQ 1301 is a queue of instructions waiting to be issued. The RS 1302 is a queue of instructions that have been already issued and are waiting to be executed. The EQ 1303 is a queue for managing running instructions. The CQ 1304 is a queue of instructions that have been executed by the calculator 103-1 and are waiting to be completed as an instruction.

Procedures for processing an instruction are described below.

A program instruction is once held in the IQ 1301 after being decoded by the decoding unit 102-1 (see FIG. 1). The instruction held in the IQ 1301 is issued to the corresponding calculator 103-1 (FIG. 1) after an instruction execution condition such as the preparation of operand data required for execution in a register, or the like is verified to be satisfied.

The issued instruction is sequentially executed by the corresponding calculator 103-1 after being moved to the RS 1302. If there is no vacancy in the corresponding RS 1302, instruction issuance from the IQ 1301 is postponed until a vacancy occurs.

The RS 1302 is a FIFO (First-In First-Out) queue. Namely, an instruction that comes first is goes out first. The instruction held in the RS 1302 is moved to the EQ 1303 if a vacancy occurs in the EQ 1303, and starts to be processed by the corresponding calculator 103-1.

However, the instruction cannot be moved from the RS 1302 to the EQ 1303 in a time period of n[τ] (n is a natural number) during which the power supply restores from OFF to ON when the power supply control is performed. In the sequence examples depicted in FIGS. 7 and 8, power-on or power-off is completed in the time period of 5 [τ]. Therefore, an instruction input to the EQ 1303 is waited for the time period of 5 [τ] or the duration of power-off, which is shorter.

The instruction within the EQ 1303 is moved to the CQ 1304 after being processed by the corresponding calculator 103-1. For an instruction that is processed in a fixed amount of time, a method for controlling the instruction to be moved to the CQ 1304 after causing the instruction to wait for the fixed amount of time within the EQ 1303 is normally adopted. There is also a method for controlling an instruction within the EQ 1303 to be moved to the CQ 1304 upon receipt of a completion notification of execution, which is made from the calculator 103-1. This method depends on an actual implementation. Therefore, the latter method is adopted in many cases for an instruction that requires a large amount of processing time.

The instruction within the CQ 1304 is completed after exceptional information and computation results, which are obtained with the process, are reflected on a register or a memory accessible by the program, and deleted from the CQ 1304.

Actually, the CQ 1304 and the EQ 1303 are implemented as a common queue, or an instruction is moved directly from the IQ 1301 to the EQ 1303 without providing the RS 1302.

The running instruction managing unit 102-3 depicted in FIG. 1 monitors the IQ 1301, the RS 1302 and the EQ 1303, which are depicted in FIG. 13 and configure the queue groups 102-2, thereby generating the power supply control signal 301 (see FIG. 3, etc.) for the power supply control. If monitoring up to the IQ 1301 imposes a heavy processing load, only the RS 1302 and the EQ 1303 may be monitored.

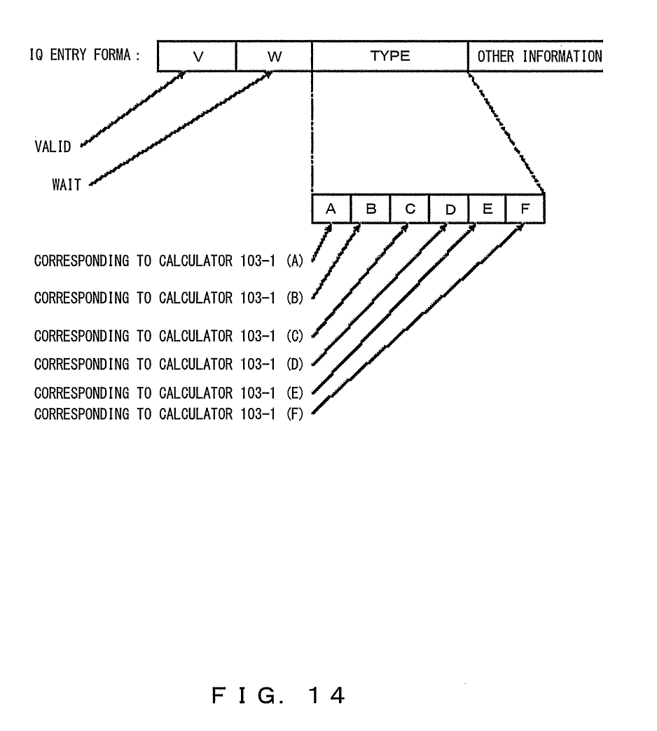

FIG. 14 is a schematic diagram depicting an example of an entry format of the IQ 1301 (FIG. 13), which is required for the power supply control.

Instruction data held in the IQ 1301 includes at least V (Valid) information, W (Wait) information, and TYPE (or instruction code) information. The V (Valid) information indicates that the corresponding entry is valid. The W (Wait) information indicates that the corresponding bit instruction is not ready to be issued. The TYPE (or instruction code) information indicates the type of the bit instruction. As a simple implementation example, the TYPE information can be represented as a bitmap corresponding to each calculator 103-1 (see FIG. 1) (calculators 103-1 of units A to F are assumed to exist in FIG. 14). The bitmap is, for example, a bitmap where 1 is set in the field of the corresponding calculator 103-1, and 0 is set in the fields of the other calculators 103-1. As another example, numbers, which are respectively assigned to the calculators 103-1, may be set as the TYPE information.

The instruction data held in the IQ 1301 further includes the storage destination of operand data of the corresponding instruction, a dependency on another instruction, and the like. However, since these items of information are not particularly required to describe the power supply control, they are omitted here (depicted as other information in FIG. 14) Information required for the power supply control in the RS 1302 and the EQ 1303 (FIG. 13) is only the V (Valid) information in the entry format of the IQ 1301.

A condition to enable the power-off of a power supply is that a valid entry where the V (Valid) information is ON does not exist in the EQ 1303 and the RS 1302 when the control is performed by monitoring only the RS 1302 and the EQ 1303.

When the control including also the condition of the IQ 1301 is performed, a power-off condition related to the IQ 1301 is extracted with the following method.

Namely, the condition to enable the power-off of the power supply is that the decoding result of the TYPE information indicates the corresponding calculator 103-1, and an instruction entry (active instruction) where the V information is ON and the W information is OFF is not held in the IQ 1301.

The W information becomes ON when the amount of time required to clear the W information is very large, such as when a process for loading data from the main memory to the register, which requires an extremely large amount of time (a large number of CPU clocks) by a current high-speed processor, is executed.

To slightly ease the power supply control, a condition that the decoding result of the TYPE information indicates the calculator 103-1 and an instruction entry where the V information is ON is not held may be available without referencing the W information in the IQ 1301.

If the condition to enable the power-off of all the EQ 1303, the RS 1302 and the IQ 1301 can be extracted, the power supply control signal 301 (FIG. 3, etc.) is transmitted from the running instruction managing unit 102-3 (FIG. 1) to the power supply control sequencer 302 (FIG. 3, etc.) within the calculator 103-1 (FIG. 1). Here, the power supply control signal 301 indicates the power-off signal to the calculator 103-1 (FIG. 1). In the examples depicted in FIGS. 6 to 10, the power supply control signal SIG1 of low level is output.

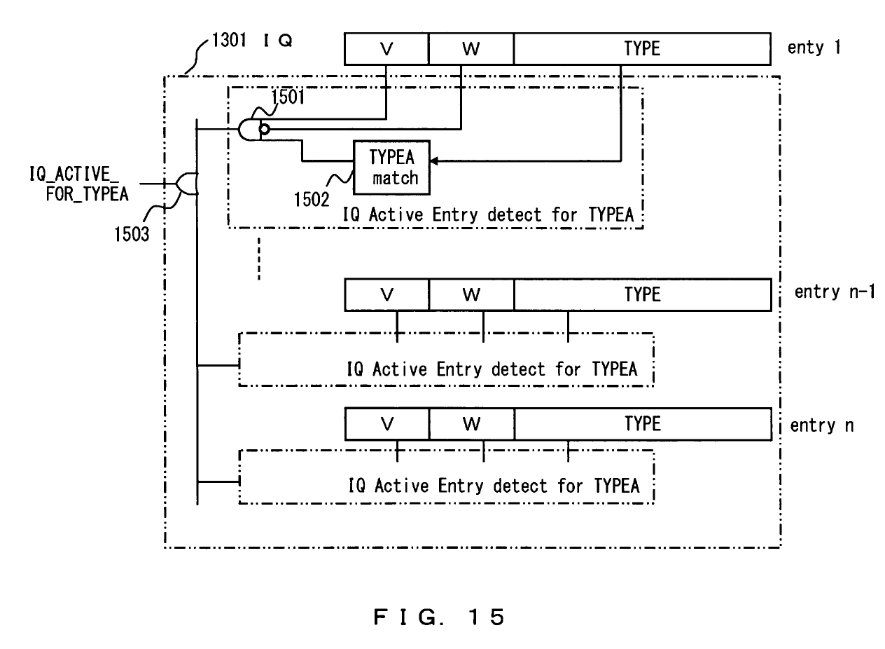

FIG. 15 is a schematic diagram depicting an example of a circuit for detecting an active instruction within the IQ 1301 (FIG. 13) to the calculator 103-1 (FIG. 1). This circuit is included in the running instruction managing unit 102-3 (FIG. 1).

FIG. 15 is a schematic diagram depicting a logic circuit for extracting the existence of the active instruction using the calculator 103-1 (unit A).

In the instruction entries (entry 1 to entry n) of the IQ 1301, V=1 and W=0 are determined by an AND circuit 1501. Then, the instruction using the calculator 103-1 of the unit A is detected via a match circuit (TYPEAmatch) 1502 that decodes the TYPE information.

In FIG. 15, a pattern indicating TYPE A is stored as the TYPE information (FIG. 14) of the IQ 1301 for the instruction using the unit A. The match circuit (TYPEAmatch) 1502 outputs 1 if the TYPE information is TYPE A. Otherwise, the match circuit outputs 0.

The AND circuit 1501 outputs 1 if an instruction entry is an entry where V=1 and W=0 and TYPE=TYPE A (the W information is input to the AND circuit 1501 with its logic inverted). Detection information about all the instruction entries (entry 1 to entry n) within the IQ 1301 are collected by an OR circuit 1503 for collecting the outputs of the AND circuits 1501 of the entries. In FIG. 15, a signal IQ_ACTIVE_FOR_TYPEA represents the existence of the active instruction using the calculator 103-1 of the unit A. If the active instruction exists within the IQ 1301, the signal IQ_ACTIVE_FOR_TYPEA becomes 1.

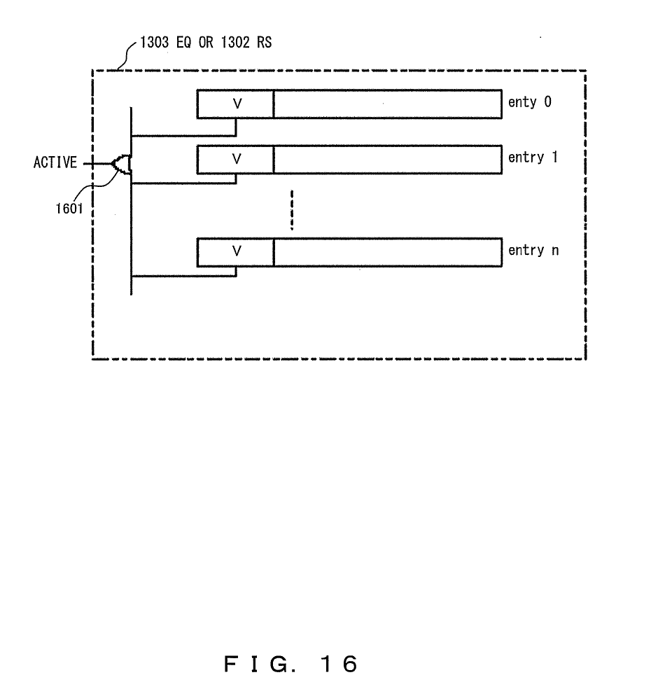

FIG. 16 is a schematic diagram depicting an example of a circuit for detecting an active instruction within the EQ 1303 or the RS 1302 (FIG. 13) to the calculator 103-1 (FIG. 1). This circuit is included in the running instruction managing unit 102-3 (FIG. 1).

In FIG. 16, the V (valid) information of instruction entries (entry 1 to entry n) within the EQ 1303 or the RS 1302 are OR-operated by an OR circuit 1601, thereby detecting the existence of an active instruction. If at least one instruction entry where V=1 exists, the output ACTIVE of the OR circuit 1601 becomes 1, which indicates the existence of a valid instruction. In the configuration depicted in FIG. 16, only the V information is determined. Therefore, this configuration is applicable to both of the RS 1302 and the EQ 1303, the conditions of which are determined based on the V information.

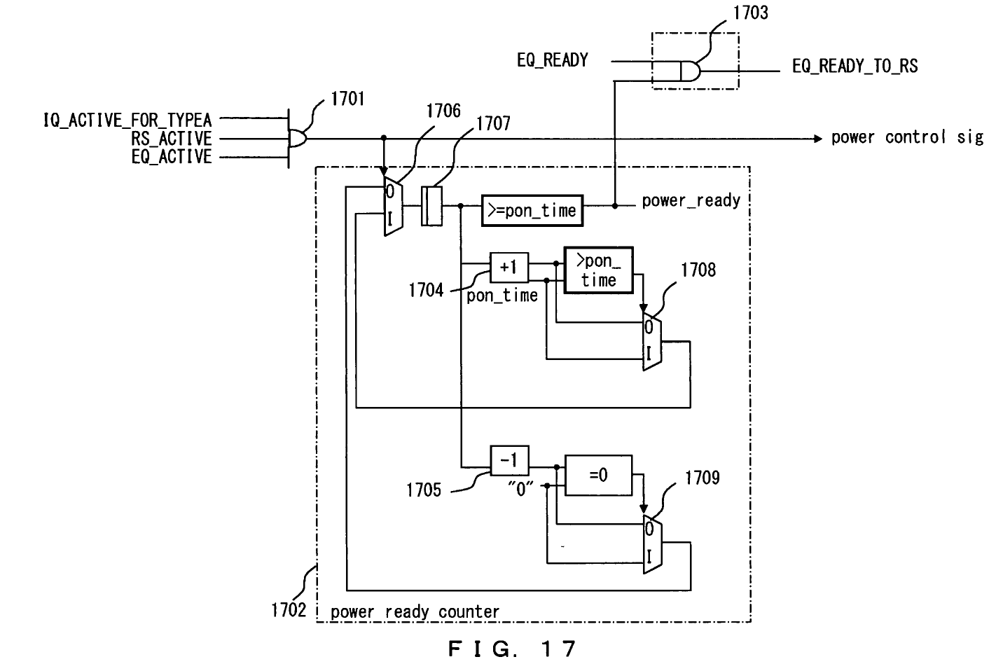

FIG. 17 is a schematic diagram depicting a configuration for creating a power supply control signal “power control sig” from valid instruction detection signals respectively corresponding to the IQ 1301, the RS 1302 and the EQ 1303, a configuration for counting the duration of power-off of a power supply, and a configuration for generating a control signal for causing a data move from the RS 1302 to the EQ 1303 (FIG. 13) to wait. The configurations depicted in FIG. 17 are included in the running instruction managing unit 102-3 (FIG. 1).

The active instruction detection signals IQ_ACTIVE_FOR_TYPEA (see FIG. 15), RS_ACTIVE and EQ_ACTIVE (both of which correspond to ACTIVE of FIG. 16), which are output from the IQ 1301, the RS 1302 and the EQ 1303, are OR-operated by an OR circuit 1701 to generate the power supply control signal “power control sig”. This signal corresponds to the power supply control signal 301 depicted in FIGS. 3 and 5, or the power supply control signal SIG1 depicted in FIG. 6, etc.

The power supply control signal “power control sig” indicates power-on if its value is 1, or indicates power-off if its value is 0.

A power ready counter 1702 is a counter that is assumed to be initialized to 0 with a power-on reset at the time of power-on. When the value of the power supply control signal “power control sig” becomes 1, a count-up (+1) circuit 1704 is activated and operates as a counter for counting up to pon_time. pon_time is a maximum amount of time required to power on the calculator 103-1.

When the value of the count-up (+1) circuit 1704 as the counter reaches pon_time, the power-on of the calculator 103-1 is complete. Then, the value of a latch circuit 1707 is set to 1 via a “1” terminal side of a selector 1708 and a “1” terminal side of a selector 1706, and a power ready signal is driven to 1.

A signal EQ_READY indicating that the next instruction entry can be input to the EQ 1303 is AND-operated with the power ready signal by an AND circuit 1703. Then, its output EQ_READY_TO_RS is notified to the RS 1302, thereby notifying the RS 1302 that an instruction input cannot be made to the RS 1302 until the completion of power-on. As a result, an instruction is controlled not to be input to the calculator 103-1 prior to the completion of power-on.

When no active instruction to the calculator 103-1 is left in the IQ 1301, the RS 1302 and the EQ 1303, the value of the power supply control signal “power control sig” becomes 0.

At the same time, a count-down (−1) circuit 1705 is activated in the power ready counter 1702. The count-down (−1) circuit 1705 continues a count-down operation until its count value becomes 0 or the value of the power supply control signal “power control sig” again becomes 1.

When the value of the count-down (−1) circuit 1705 as the counter becomes 0, the power-off of the calculator 103-1 is complete. Then, the value of the latch circuit 1707 is set to 0 via a “1” terminal side of a selector 1709 and a “0” terminal side of the selector 1706, and the power ready signal is driven to 0.

The power ready counter 1702 switches its operation in accordance with the value of the power supply control signal “power control sig” as described above. Accordingly, when the value of “power control sig” becomes 1 during the count-down operation, pon_time is reached by performing the count-up operation by the current count-down value, and an instruction input can be made to the EQ 1303. Accordingly, this operation well matches the above described operations of the power supply control sequencer 302 (FIG. 3, etc.) that waits for only the duration of power-off or pon_time, which is shorter.

As described above, the load of current fluctuations imposed on a power supply can be minimized when a particular computation block is powered off during the operations of an LSI.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A processor including a plurality of computation circuit blocks each having a function to perform a computation for each of a plurality of pieces of divided data to be computed, which are divided based on bit positions of data to be computed, and a function to power on/off each power supply, the processor comprising:
a signal value fixing circuit, which is provided for each of the computation circuit blocks, for fixing one or both of signal values of an input and an output of each of the computation circuit blocks; and
a power supply control sequencer circuit for instructing each signal value fixing circuit to fix a signal value and to release the signal value from being fixed, and for respectively instructing the computation circuit blocks to power on/off each power supply in a step-by-step manner on the basis of a power supply control signal provided from an instruction controlling circuit for controlling an input of a computation instruction to the processor.

2. The processor according to claim 1, wherein
the power supply control sequencer circuit respectively instructs the computation circuit blocks to power off each power supply in a step-by-step manner from the computation circuit block on a most significant bit side of the data to be computed after instructing the each signal value fixing circuit to fix a signal value on an input side, if the power supply control signal instructs power-off of a power supply, and
the power supply control sequencer circuit instructs the each signal value fixing circuit to release the signal value on the input side from being fixed after respectively instructing the computation circuit blocks to power on each power supply in a step-by-step manner from the computation circuit block on a least significant bit side of the data to be computed, if the power supply control signal instructs power-on of a power supply.

3. The processor according to claim 1, wherein
the power supply control sequencer circuit respectively instructs the computation circuit blocks to power off each power supply in a step-by-step manner from the computation circuit block on a most significant bit side of the data to be computed, and also instructs the signal value fixing circuit, which corresponds to the computation circuit block instructed to power off the power supply, to fix a signal value on an output side after instructing the each signal value fixing circuit to fix a signal value on an input side, if the power supply control signal instructs the power-off of a power supply, and
the power supply control sequencer circuit instructs the each signal value fixing circuit to release the signal value on the input side from being fixed after respectively instructing the computation circuit blocks to power on each power supply in a step-by-step manner from the computation circuit block on a least significant bit side of the data to be computed, and also instructing the signal value fixing circuit, which corresponds to the computation circuit block instructed to power on the power supply, to release the signal value on the output side from being fixed, if the power supply control signal instructs the power-on of a power supply.

4. A processor including a first computation circuit for performing a computation for first divided data to be computed, which is divided based on bit positions of data to be computed, a second computation circuit for performing a computation for second divided data to be computed that is divided on bit positions of the data to be computed and different from the first data, and a control circuit for controlling the first computation circuit and the second computation circuit, wherein:
the first computation circuit comprises
a first input value fixing circuit, to which the first divided data to be computed is input, for outputting one of the first divided data to be computed and a first fixed input value on the basis of a first fixed value control signal, and
a first divided computation circuit for performing a first computation for the first divided data to be computed, and for outputting first divided computed output data;
the second computation circuit comprises
a second input value fixing circuit, to which the second divided data to be computed is input, for outputting one of the second divided data to be computed and a second fixed input value on the basis of a second fixed value control signal, and
a second divided computation circuit for performing a second computation for the second divided data to be computed, and for outputting second divided computed output data; and
the control circuit outputs the first fixed value control signal to the first computation circuit, and outputs the second fixed value control signal to the second computation circuit on the basis of an external control signal input externally to the control circuit.

5. The processor according to claim 4, wherein:
the first computation circuit is connected to the second computation circuit via a carry signal fixing circuit, and outputs a carry signal to the second computation circuit; and
the carry signal fixing circuit suppresses a carry signal output from the first computation circuit to the second computation circuit on the basis of the second fixed value control signal, and outputs a third fixed value.

6. The processor according to claim 4, wherein
the first computation circuit further comprises
a first output value fixing circuit, to which the first divided computed output data is input, outputs one of the first divided computed output data and a second fixed output value on the basis of the first fixed value control signal, and
a second output value fixing circuit, to which the second divided computed output data is input, outputs one of the second divided computed output data and a second fixed output value on the basis of the second fixed value control signal.

7. The processor according to claim 4, wherein
the control circuit outputs to the first computation circuit a first power supply control signal for controlling a power supply of the first computation circuit, and outputs to the second computation circuit a second power supply control signal for controlling a power supply of the second computation circuit on the basis of an external control signal input externally to the control circuit.

8. A power supply controlling method of a processor including a plurality of computation circuit blocks each having a function to perform a computation for each of a plurality of pieces of divided data to be computed, which are divided based on bit positions of data to be computed, and a function to power on/off each power supply, the method comprising:
controlling an input of a computation instruction to the processor using a signal for instructing power-off of a power supply;
instructing the computation circuit blocks respectively to fix a signal value on an input side;
instructing the computation circuit blocks respectively to power off each power supply in a step-by-step manner from the computation circuit block on a most significant bit side of the data to be computed;
instructing the computation circuit blocks respectively to power on each power supply in a step-by-step manner from the computation circuit block on a least significant bit side of the data to be computed; and
instructing the computation circuit blocks respectively to release the signal value on the input side from being fixed.

9. The power supply controlling method according to claim 8, further comprising:
instructing the computation circuit blocks instructed respectively to power off each power supply to fix a signal value on an output side, if the computation circuit blocks are respectively instructed to power off each power supply in a step-by-step manner from the computation circuit block on the most significant bit side of the data to be computed; and
instructing the computation circuit blocks instructed respectively to power on each power supply to release the signal value on the output side from being fixed, if the computation circuit blocks are respectively instructed to power on each power supply in a step-by-step manner from the computation circuit block on the least significant bit side of the data to be computed.
